(19) United States
(12) Patent Application Publication
(10) Pub. No.: US 2012/0129563 A1
(43) Pub. Date: May 24, 2012

(54) Method for Setting of a Transmission Power

(75) Inventor: Wolfgang Haas, Perchtoldsdorf (AT)

(73) Assignee: GIGASET COMMUNICATIONS GMBH, Munich (DE)

(21) Appl. No.: 12/529,332

(22) PCT Filed: Mar. 7, 2008
(86) PCT No.: PCT/EP08/52742

§ 371 Date: Mar. 31, 2010

(30) Foreign Application Priority Data
Mar. 13, 2007 (DE) 10 2007 012 051.8

(51) Int. Cl. H04W 52/30

(52) U.S. Cl. 455/522

(57) ABSTRACT

Based on a method used in a wireless communication system (for example WiMAX), wherein a possible successful transmission power (C) for detecting a transmitter by a receiver is calculated, in order to achieve a faster detection of the transmitter by the receiver, a method is proposed, wherein from the calculated transmission power (C) a permissible maximum (D) and a permissible minimum (E) transmission power are determined. At a starting time, a transmission power (G) is set, which is below the calculated transmission power (C) and above the determined permissible minimum transmission power (E). The transmission power is then increased incrementally (F) until the determined permissible maximum transmission power (D) is reached. Upon reaching the determined permissible maximum transmission power (D), the transmission power is then increased incrementally (F) from the determined permissible minimum transmission power (E) until the determined permissible maximum transmission power (D) is reached again and is continued, until the transmitter is detected by the receiver or until further steps are initiated.

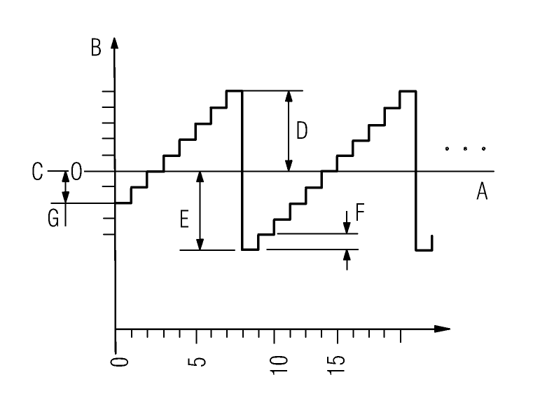

The invention relates to a method for setting a transmission power in accordance with the preamble of claim 1.

There is a wireless communication system known by the English term “wireless communication system (WiMAX).” Such a system operates, for example, in accordance with IEEE standard 802.16d.

Such a system operates, for example, between a terminal functioning as a transmitter and a base station functioning as a receiver, between which there is an air interface.

Communication will be established only when the base station detects the terminal, i.e., when the transmission power of the terminal is high enough for the base station to detect the terminal, but at the same time the transmission power is not high enough to overload the base station.

It should be mentioned here that when the communication direction is reversed the same principle can apply, in which case the devices referred to above simply trade the transmitting and receiving functions.

During an initialization phase in a synchronization cycle in a WiMAX system the transmitting power of the terminal will be set such that the base station can detect the terminal.

The transmitting power of the terminal will be set in accordance with a ramp function. A number of possible settings will simply be tried until the base station detects the terminal.

This procedure suffers from the drawback that the search can occasionally take a long time.

Based on a method of the type referred to at the outset, the object of the present invention is to improve a method of this type technically such that the time interval elapsing to the point at which the transmitting power of a transmitter reaches the proper setting, such that an assigned receiver detects, or can receive, the transmitter, is decreased at least statistically.

According to the invention, this object is accomplished by means of a method possessing the features specified in the characterizing portion of claim 1.

Accordingly, the method includes a step at which, based upon a computed most likely successful transmission power, a permissible maximum and a permissible minimum transmission power are determined. Then, in a further step in the process, at a starting time, the transmitter sets a transmitting power which is lower than the computed and higher than the determined permissible minimum transmitting power. The transmitter then increases transmission power stepwise until it reaches the determined permissible maximum transmission power. When the transmitter reaches the determined permissible maximum transmitting power, it then increases transmitting power stepwise from the determined permissible minimum transmitting power until it reaches the determined permissible maximum transmitting power again. This process will be repeated each time the determined permissible maximum transmitting power is reached. When the receiver finally detects the transmitter, the transmitter switches into an operating mode at the current transmission power setting.

With the establishment of permissible minimum and permissible maximum transmitting powers around a computed most probably successful transmitting power, it will be ensured that the receiver is not overloaded and at the same time need not test unnecessarily low transmitting powers.

The selection of an initial value for the transmitting power lower than the computed most probably successful transmitting power and higher than the determined permissible minimum transmitting power takes account of the fact that what are referred to as fading effects may occur, due to which free-space attenuation, or attenuation across the air interface, can be computed as too high.

Because ultimately this initial transmitting power can also be too low, on the basis of this initial transmitting power, the transmitting power will be increased by a predetermined amount with each iteration.

As soon as the determined permissible maximum transmitting power is reached, the transmitter begins again with the determined permissible minimum transmitting power to increase the transmitting power stepwise until the receiver has detected the transmitter.

The advantage of this method consists in the fact that, at least statistically, a receiver detects the transmitter in an above specified system in a shorter time than was previously the case.

Useful embodiments of the invention constitute the subject matter of dependent claims.

Accordingly, after the determined permissible maximum transmitting power is reached a process step will be initiated at which a most probable successful transmitting power is again computed. Subsequent steps will then be executed at the newly computed most probably successful transmitting power, or alternatively, at the determined permissible minimum transmitting power, or else at a transmitting power below the newly computed most probably successful transmitting power and above the determined permissible minimum transmitting power.

The advantage here consists in the fact that this would permit continuous adjustment to real-time conditions.

In another useful embodiment of the invention, each time the most probably successful transmitting power is recomputed, the permissible maximum and minimum transmitting power will also be reestablished.

The advantage in this case consists in the fact that it permits better adjustment to real-time conditions.

In another useful embodiment of the invention, the method according to the invention is implemented in a system referred to as a “wireless communication system (WiMAX),” whereby a most probably successful transmitting power (P_{TX}_{_{—}}_{IR}_{_{—}}_{MAX}) will be computed which, ideally, can then be used for the method according to the invention.

Finally, in another useful embodiment of the invention, in at least one intermediate step, a time check is added which will indicate if the receiver has not detected the transmitter for a specified period of time. An otherwise possibly nonstop active detection mode, or the current process, can then either immediately or at a later time be discontinued.

An exemplary embodiment of the invention is explained in greater detail below with reference to a diagram.

The single diagram shows one possible sequence for setting the transmitting power of a transmitter in an initialization phase in a wireless communication system (WiMAX), in which a receiver attempts to detect the transmitter.

The diagram shows a coordinate system A/B, in which iteration steps are plotted from left to right along the abscissa A. Along the ordinate beginning at a 0 line, which will always correspond to a computed most probably successful transmitting power C (P_{TX}_{_{—}}_{IR}_{_{—}}_{MAX}), depending upon the computed most probably successful transmitting power C, a determined permissible maximum transmitting power will be entered at interval D in the positive direction and a determined permissible minimum transmitting power will be entered at interval E in the negative direction. At each individual iteration step, power will change by a magnitude F with the iterative setting of the transmitting power.

As can be seen from the FIGURE, the power setting process begins at a value lower than the computed most probably successful transmitting power C and at the same time higher than the determined permissible minimum transmitting power E. This difference G can be referred to as an initial backstep.

Transmitting power will then be increased stepwise until it reaches the determined permissible maximum transmitting power D.

According to the FIGURE, the process then continues with the determined permissible minimum transmitting power E.

Either the receiver has already detected the transmitter, which is the case as a rule, because the process is geared toward the computed most probably successful transmitting power, or, because of time, the detection process, or the current process, will be discontinued; or another most probably successful transmitting power will be computed and, taking this new most probably successful transmitting power into account, the process will either continue or restart.

What is claimed is:

1. Method for setting the transmitting power of a transmitter such that a receiver can receive the transmitter and incorporating a step in which a most probably successful transmitting power is computed, and a step in which the receiver indicates that the transmitter has been detected, characterized in that, on the basis of the computed transmitting power (C), a permissible maximum (D) and a permissible minimum (E) transmitting power will be determined; at a start time the transmitter will set a transmitting power (G) which is lower than the computed transmitting power (C) and higher than the determined permissible minimum transmitting power (E); the transmitter will then by steps incrementally increase the transmitting power until it reaches the determined permissible maximum transmitting power (D); upon reaching the determined permissible maximum transmitting power (D) the transmitter will then by steps (F) increase transmitting power incrementally from the determined permissible minimum transmitting power (E) until it again reaches the determined permissible maximum transmitting power (D) and will repeat this sequence of steps each time it reaches the determined permissible maximum transmitting power (D), the transmitter then switching the system to an operating mode at the current transmitting power setting when the receiver indicates that it has detected the transmitter.

2. Method according to claim 1 characterized in that when the determined permissible maximum transmitting power (D) is reached, a step will be initiated, at which a most probably successful transmitting power (C) will again be computed, and at which subsequent steps, now oriented toward the new computed transmitting power (C), or alternatively, toward the determined permissible minimum transmitting power (E), or else toward a transmitting power which is lower than the newly computed transmitting power (C) and higher than the determined permissible minimum transmitting power (E), will be continued.

3. Method according to claim 2 characterized in that each time the transmitting power (C) is recomputed, the permissible maximum (D) and permissible minimum (E) transmitting powers will also be reestablished.

4. Method according to claim 1 characterized in that it is implemented in what is referred to as a wireless communication system (WiMAX), in which a most probably successful transmitting power (C) is computed.

5. Method according to claim 1 characterized in that in at least one intermediate step there will be a timing check procedure, which generates a control signal if the receiver does not detect the transmitter for a specified period of time and which is used to terminate an active detection mode or the current process either immediately or at a later time.
